(19) United States
(12) Patent Application Publication
(10) Pub. No.: US 2005/0203877 A1
(43) Pub. Date: Sep. 15, 2005

(54) Chain rule processor

(76) Inventor: Paul M. Baggenstoss, Newport, RI (US)

Correspondence Address: NAVAL UNDERSEA WARFARE CENTER;DIVISION NEWPORT, 1176 HOWELL STREET, CODE 000C, BLDG 112T, NEWPORT, RI, 02841, US

(21) Appl. No.: 10/789,050

(22) Filed: Feb. 27, 2004

(51) Int. Cl. G06F 7/00

(52) U.S. Cl. 707/3

(57) ABSTRACT

A modularized classifier is provided which includes a plurality of class specific modules. Each module has a feature calculation section, and a correction section. The modules can be arranged in chains of modules where each chain is associated with a class. The first module in the chain receives raw input data and subsequent modules act on the features provided by the previous module. The correction section acts on the previously computed correction. Each chain is terminated by a probability density function evaluation module. The output of the evaluation module is combined with the correction value of the last module in the chain. This combined output is provided to a compare module that indicates the class of the raw input data.

### STATEMENT OF GOVERNMENT INTEREST

The invention described herein may be manufactured and used by or for the Government of the United States of America for governmental purposes without the payment of any royalties thereon or therefor.

### BACKGROUND OF THE INVENTION

(1) Field of the Invention

This invention generally relates to a signal-classification system for classifying an incoming data stream. More particularly, the invention relates to a modularized classifier system that can be used for easily assembling different classifiers.

(2) Description of the Prior Art

In order to determine the nature of an incoming signal, the signal type must be determined. A classifier attempts to classify a signal into one of M signal classes based on features in the data. M-ary classifiers utilize neural networks for extracting these features from the data. In a training stage the neural networks incorporated in the classifier are trained with labeled data allowing the neural networks to learn the patterns associated with each of the M classes. In a testing stage, the classifier is tested against unlabeled data based on the learned patterns. The performance of the classifier is defined as the probability that a signal is correctly classified.

The so-called M-ary classification problem is that of assigning a multidimensional sample of data xεR^{N} to one of M classes. The statistical hypothesis that class j is true is denoted by Hⱼ, 1≦j≦M. The statistical characterization of x under each of the M hypotheses is described completely by the probability density functions (PDFs), written p(x|Hⱼ), 1≦j≦M. Classical theory as applied to the problem results in the so-called Bayes classifier, which simplifies to the Neyman-Pearson rule for equiprobable prior probabilities:

$${j}^{*} = arg {max}_{j} p ( x \vert {H}_{j} ) . \qquad ( 1 )$$

Because this classifier attains the minimum probability of error of all possible classifiers, it is the basis of most classifier designs. Unfortunately, it does not provide simple solutions to the dimensionality problem that arises when the PDFs are unknown and must be estimated. The most common solution is to reduce the dimension of the data by extraction of a small number of information-bearing features z=T(x) then recasting the classification problem in terms of z:

$${j}^{*} = arg {max}_{j} p ( z \vert {H}_{j} ) . \qquad ( 2 )$$

This leads to a fundamental tradeoff: whether to discard features in an attempt to reduce the dimension to something manageable or to include them and suffer the problems associated with estimating a PDF at high dimension. Unfortunately, there may be no acceptable compromise. Virtually all methods which attempt to find decision boundaries on a high-dimensional space are subject to this tradeoff or “curse” of dimensionality. For this reason, many researchers have explored the possibility of using class-specific features.

The basic idea in using class-specific features is to extract M class-specific feature sets zⱼ=Tⱼ(x), 1≦j≦M where the dimension of each feature set is small, and then to arrive at a decision rule based only upon functions of the lower dimensional features. Unfortunately, the classifier modeled on the Neyman-Pearson rule

$${j}^{*} = arg {max}_{j} p ( {z}_{j} \vert {H}_{j} ) . \qquad ( 3 )$$

is invalid because comparisons of densities on different feature spaces are meaningless. One of the first approaches that comes to mind is to computes for each class a likelihood ratio against a common hypothesis composed of “all other classes.” While this seems beneficial on the surface, there is no theoretical dimensionality reduction since for each likelihood ratio to be a sufficient statistic, “all features” must be included when testing each class against a hypothesis that includes “all other classes.” A number of other approaches have emerged in recent years to arrive at meaningful decision rules. Each method makes a strong assumption (such as that the classes fall into linear subspaces) that limits the applicability of the method or else uses ad hoc method of combining the likelihoods of the various feature sets.

Prior art methods include the following. A method used in speech recognition (Frimpong-Ansah, K. Pearce, D. Holmes, and W. Dixon, “A stochastic/feature based recognizer and its training algorithm,” in Proc. ICASSP, vol. 1, 1989, pp. 401-404.) uses phoneme-specific features. While, at first, this method appears to use class-specific features, it is actually using the same features extracted from the raw data but applying different models to the time evolution of these features.

A method of image recognition (E. Sali and S. Ullman, “Combining class-specific fragments for object classification,” in Proc. British Machine Vision Conf., 1999, pp. 203-213.) uses class-specific features to detect various image “fragments.” The method uses a nonprobabilistic means of combining fragments to form an image.

A method has been proposed that tests all pairs of classes (S. Kumar, J. Ghosh, and M. Crawford, “A versatile framework for labeling imagery with large number of classes,” in Proc. Int. Joint Conf. Neural Networks, Washington, D.C., 1999, pp. 2829-2833.). To be exhaustive, this method has a complexity of 0(M²) different tests and may be prohibitive for large M. A hierarchical approach has been proposed based on a binary tree of tests (“A hierarchical multiclassifier system for hyperspectral data analysis,” in Multiple Classifier Systems, J. Kittler and F. Roli, Eds. New York: Springer, 2000, pp. 270-279). Implementation of the binary tree requires initial classification into meta-classes, which is an approach that is suboptimal because it makes hard decisions based on limited information.

Methods based on linear subspaces (H. Watanabe, T. Yamaguchi, and S. Katagiri, “Discriminative metric design for robust pattern recognition,” IEEE Trans. Signal Processing, vol. 45, pp. 2655-2661, November 1997. P. Belhumeur, J., Hespanha, and D. Kriegman, “Eigenfaces vs. Fisherfaces: Recognition using class specific linear projection,” IEEE Trans. Pattern Anal. Machine Intell., vol. 19, pp. 711-720, July 1997.) are popular because they use the powerful tool of linear subspace analysis. These methods can perform well in certain applications but are severely limited to problems where when the classes are separable by linear processing.

Support vectors (D. Sebald, “Support vector machines and the multiple hypothesis test problem,” IEEE Trans. Signal Processing, vol. 49, pp. 2865-2872, November 2001.) are a relatively new approach that is based on finding a linear decision function between every pair of classes.

The inventor has also developed a prior class specific classifier, U.S. Pat. No. 6,535,641, showing a class specific classifier for classifying data received from a data source. The classifier has a feature transformation section associated with each class of data which receives the data and provides a feature set for the associated data class. Each feature transformation section is joined to a pattern matching processor which receives the associated data class feature set. The pattern matching processors calculate likelihood functions for the associated data class. One normalization processor is joined in parallel with each pattern matching processor for calculating an inverse likelihood function from the data, the associated class feature set and a common data class set. The common data class set can be either calculated in a common data class calculator or incorporated in the normalization calculation. The inverse likelihood function is then multiplied with the likelihood function for each associated data class. A comparator provides a signal indicating the appropriate class for the input data based upon the highest multiplied result.

As evidenced by the various approaches, there is a strong motivation for using class-specific features. Unfortunately, classical theory as it stands requires operating in a common feature space and fails to provide any guidance for a suitable class-specific architecture.

### SUMMARY OF THE INVENTION

Therefore, it is one purpose of this invention to provide a class specific classifier.

Another purpose of this invention is a classifier architecture having reusable modules.

Accordingly, there is provided a modularized classifier which includes a plurality of class specific modules. Each module has a feature calculation section, and a correction section. The modules can be arranged in chains of modules where each chain is associated with a class. The first module in the chain receives raw input data and subsequent modules act on the features provided by the previous module. The correction section acts on the previously computed correction. Each chain is terminated by a probability density function evaluation module. The output of the evaluation module is combined with the correction value of the last module in the chain. This combined output is provided to a compare module that indicates the class of the raw input data. The invention may be implemented either as a device or a method operating on a computer.

### BRIEF DESCRIPTION OF THE DRAWINGS

The appended claims particularly point out and distinctly claim the subject matter of this invention. The various objects, advantages and novel features of this invention will be more fully apparent from a reading of the following detailed description in conjunction with the accompanying drawings in which like reference numerals refer to like parts, and in which:

FIG. 1 is a diagram illustrating the chain rule used in this invention;

FIG. 2 is a block diagram of a first example of a classifier implemented utilizing the preferred architecture of the current invention;

FIG. 3 is a block diagram of a second example of a classifier implemented utilizing an alternative architecture of the current invention; and

FIG. 4 is a block diagram of an embodiment of a classifier implemented utilizing another alternative architecture of the current invention.

### DESCRIPTION OF THE PREFERRED EMBODIMENT

It is well known how to write the PDF of x from the PDF of z when the transformation is 1:1. This is the change of variables theorem from basic probability. Let z=T(x), where T(x) is an invertible and differentiable multidimensional transformation. Then,
pₓ(x)=|J(x)|p_{z}(T(x)), (4)
where |J(x)| is the determinant of the Jacobian matrix of the transformation

$${J}_{ij} = \frac{{\partial }_{zi}}{{\partial }_{xj}} . \qquad ( 5 )$$

What we seek is a generalization of (4) which is valid for many-to-1 transformations. Define
P(T,p_{z})={p_{z}(x):z=T(x) and z˜p_{z}(z)}, (6)
that is, P(T,p_{z}) is the set of PDFs p_{z}(x) which through T(x) generates PDF p_{z}(z) on z. If T( ) is many-to-one, P(T,p_{z}) will contain more than one member. Therefore, it is impossible to uniquely determine pₓ(x) from T( ) and p_{z}(z). We can, however, find a particular solution if we constrain pₓ(x) such that, for every transform pair (x,z), we have:

$$\frac{{p}_{x} ( x )}{{p}_{x} ( x \vert {H}_{0} )} = \frac{{p}_{z} ( z )}{{p}_{z} ( z \vert {H}_{0} )} , \qquad ( 7 )$$

or that the likelihood ratio, (with respect to H₀) is the same in both the raw data and feature domains for some pre-determined reference hypothesis H₀. We will soon show that this constraint produces desirable properties. The particular form of pₓ(x) is uniquely defined by the constraint itself, namely

$${p}_{x} ( x ) = \frac{{p}_{z} ( x \vert {H}_{0} )}{{p}_{z} ( z \vert {H}_{0} )} {p}_{z} ( z ) ; at z = T ( x ) . \qquad ( 8 )$$

The PDF projection theorem proves that (8) is, indeed, a PDF and a member of P(T,p_{z}). Under this theorem let Ho be some fixed reference hypothesis with known PDF pₓ(x|H₀). Let λ be the region of support of pₓ(x|H₀). In other words λ is the set of all points x where pₓ(x|H₀)>0. Let z=T(x) be a continuous many-to-one transformation (the continuity requirement may be overly restrictive). Let Z be the image of λ under the transformation T(x). Let p_{z}(z|H₀) be the PDF of z when x is drawn from pₓ(x|H₀). It follows that p_{z}(z|H₀)>0 for all zεZ. Now, let be a any other PDF with the same region of support Z. Then the function (8) is a PDF on λ, thus
∫_{xελ}pₓ(x)dx=1. (9)
Furthermore, pₓ(x) is a member of P(T,p_{z}).

The theorem shows that, provided we know the PDF under some reference hypothesis H₀ at both the input and output of transformation T(x), if we are given an arbitrary PDF p_{z}(z) defined on z, we can immediately find a PDF pₓ(x) defined on x that generates p_{z}(z). Although it is interesting that pₓ(x) generates p_{z}(z), there are an infinite number of them, and it is not yet clear that pₓ(x) is the best choice. However, suppose we would like to use pₓ(x) as an approximation to the PDF pₓ(x|H₁). Let this approximation be

$${\hat{p}}_{x} ( x \vert {H}_{1} ) ≡ \frac{{p}_{x} ( x \vert {H}_{0} )}{{p}_{z} ( z \vert {H}_{0} )} {\hat{p}}_{z} ( z \vert {H}_{1} ) at z = T ( x ) . \qquad ( 10 )$$

From the PDF projection theorem, we see that (10) is a PDF. Furthermore, if T(x) is a sufficient statistic for H₁ vs H₀, then as \hat{p}_{z}(z|H₁)→p_{z}(z|H₁), we have
\hat{p}ₓ(x|H₁)→pₓ(x|H₁). (11)
This is immediately seen from the well-known property of the likelihood ratio, which states that if T(x) is sufficient for H₁ versus H₀:

$$\frac{{p}_{x} ( x \vert {H}_{1} )}{{p}_{x} ( x \vert {H}_{0} )} = \frac{{p}_{z} ( z \vert {H}_{1} )}{{p}_{z} ( z \vert {H}_{0} )} \qquad ( 12 )$$

Note that for a given H₁, the choice of T(x) and H₀ are coupled so that they must be chosen jointly. In addition, note that the sufficiency condition is required for optimality, but is not necessary for (10) to be a valid PDF. Here, we can see the importance of the theorem. The theorem, in effect, provides a means of creating PDF approximations on the high-dimensional input data space without dimensionality penalty using low-dimensional feature PDFs and provides a way to optimize the approximation by controlling both the reference hypothesis Ho as well as the features themselves. This is the remarkable property of the theorem: that the resulting function remains a PDF whether or not the features are sufficient statistics. Since sufficiency means optimality of the classifier, approximate sufficiency means PDF approximation and approximate optimality.

The PDF projection theorem allows maximum likelihood (ML) methods to be used in the raw data space to optimize the accuracy of the approximation over T and H₀ as well as θ. Let \hat{p}_{z}(z|H₁) be parameterized by the parameter θ. Then, the maximization

$${max}_{θ , T , {H}_{0}} \{ \frac{{p}_{x} ( x \vert {H}_{0} )}{{p}_{z} ( z \vert {H}_{0} )} {\hat{p}}_{z} ( z \vert {H}_{1} ; θ ) , z = T ( x ) \} \qquad ( 13 )$$

is a valid ML approach and can be used for model selection (with appropriate data cross-validation).

We now mention a useful property of (7). Let H_{z} be a region of sufficiency (ROS) of z, which is defined as a set of all hypotheses such that for every pair of hypotheses H₀ₐ, H_{0b}εH_{z}, we have

$$\frac{{p}_{x} ( x \vert {H}_{0 a} )}{{p}_{x} ( x \vert {H}_{0 b} )} = \frac{{p}_{z} ( z \vert {H}_{0 a} )}{{p}_{z} ( z \vert {H}_{0 b} )} \qquad ( 14 )$$

An ROS may be thought of as a family of PDFs traced out by the parameters of a PDF, where z is a sufficient statistic for the parameters. The ROS may or may not be unique. For example, the ROS for a sample mean statistic could be a family of Gaussian PDFs with variance 1 traced out by the mean parameter. Another ROS would be produced by a different variance. The “j-function”

$$J ( x , T , {H}_{0} ) ≡ \frac{{p}_{x} ( x \vert {H}_{0} )}{{p}_{x} ( T ( x ) \vert {H}_{0} )} = \frac{p ( x \vert {H}_{0} )}{p ( z \vert {H}_{0} )} \qquad ( 15 )$$

is independent of H₀ as long as H₀ remains within ROS H_{z}. Defining the ROS should in no way be interpreted as a sufficiency requirement for z. All statistics z have an ROS that may or may not include H₁ (it does only in the ideal case). Defining H_{z} is used only in determining the allowable range of reference hypotheses when using a data-dependent reference hypothesis. For example, let z be the sample variance of x. Let H₀(σ²) be the hypothesis that x is a set of N independent identically distributed zero-mean Gaussian samples with variance σ². Clearly, an ROS for z is the set of all PDFs traced out by σ². We have

$$p ( x \vert {H}_{0} ( {σ}^{2} ) ) = {( 2 π {σ}^{2} )}^{- N / 2} exp \{ \frac{- 1}{2 {σ}^{2}} {\sum }_{n = 1}^{N} {x}_{i}^{2} \} \qquad ( 16 )$$

and, since z is a λ²(N) random variable (scaled by 1/N)

$$p ( z \vert {H}_{0} ( {σ}^{2} ) ) = \frac{N}{{σ}^{2} Γ ( \frac{N}{2} )} {2}^{- N / 2} {( \frac{{N}_{z}}{{σ}^{2}} )}^{N / 2 - 1} exp ( - \frac{zN}{2 {σ}^{2}} ) . \qquad ( 17 )$$

It is easily verified that the contribution of σ² is canceled in the J-function ratio.

Because J(x, T, H₀(σ²)) is independent of σ², it is possible to make σ² a function of the data itself, changing it with each input sample. In the example above, since z is the sample variance, we could let the assumed variance under H₀ depend on z according to σ²=z.

However, if J(x, T, H₀(σ²)) is independent of σ², one may question what purpose does it serve to vary σ². The reason is purely numerical. Note that in general, we do not have an analytic form for the J-function but instead have separate numerator and denominator terms. Often, computing J(x, T, H₀(σ²)) can pose some tricky numerical problems, particularly if x and z are in the tails of the respective PDFs. Therefore, our approach is to position H₀ to maximize the numerator PDF (which simultaneously maximizes the denominator). Another reason to do this is to allow PDF, approximations to be used in the denominator that are not valid in the tails, such as the central limit theorem (CLT).

In our example, the maximum of the numerator clearly happens at σ²=z because z is the maximum likelihood estimator of σ². We will explore the relationship of this method to asymptotic ML theory in a later section. To reflect the possible dependence of H₀ on z, we adopt the notation H₀(z). Thus

$${\hat{p}}_{x} ( x \vert {H}_{1} ) ≡ \frac{{p}_{x} ( x \vert {H}_{0} ( z ) )}{{p}_{z} ( z \vert {H}_{0} ( z ) )} {\hat{p}}_{z} ( z \vert {H}_{1} ) , where z = T ( x ) . \qquad ( 18 )$$

The existence of z on the right side of the conditioning operator | is admittedly a very bad use of notation but is done for simplicity. The meaning of z can be understood using the following imaginary situation. Imagine that we are handed a data sample x, and we evaluate (10) for a particular hypothesis H₀εH_{z}. Out of curiosity, we try it again for a different hypothesis of H′₀εH_{z}. We find that no matter which H₀εH_{z} we use, the result is the same. We notice, however, that for an Ho that produces larger values of pₓ(x|H₀(z)) and p_{z}(z|H₀(z)), the requirement for numerical accuracy is less stringent. It may require fewer terms in a polynomial expansion or else fewer bits of numerical accuracy. Now, we are handed a new sample of x, but this time, having learned our lesson, we immediately choose the H₀εH_{z} that maximizes pₓ(x|H₀(z)). If we do this every time, we realize that H₀ is now a function of z. The dependence, however, carries no statistical meaning and only has a numerical interpretation. This is addressed below in the text differentiating a fixed reference hypothesis from a variable reference hypothesis.

In many problems H_{z} is not easily found, and we must be satisfied with approximate sufficiency. In this case, there is a weak dependence of J(x, T, H₀) upon H₀. This dependence is generally unpredictable unless, as we have suggested, H₀(z) is always chosen to maximize the numerator PDF. Then, the behavior of J(x, T, H₀) is somewhat predictable. Because the numerator is always maximized, the result is a positive bias. This positive bias is most notable when there is a good match to the data, which is a desirable feature.

We have stated that when we use a data-dependent or variable reference hypothesis, we prefer to choose the reference hypothesis such that the numerator of the J-function is a maximum. Since we often have parametric forms for the PDFs, this amounts to finding the ML estimates of the parameters. If there are a small number of features, all of the features are ML estimators for parameters of the PDF, and there is sufficient data to guarantee that the ML estimators fall in the asymptotic (large data) region, then the variable hypothesis approach is equivalent to an existing approach based on classical asymptotic ML theory. We will derive the well-known asymptotic result using (18).

Two well-known results from asymptotic theory are the following. First, subject to certain regularity conditions (large amount of data, a PDF that depends on a finite number of parameters and is differentiable, etc.), the PDF pₓ(x; θ*) may be approximated by

$${p}_{x} ( x ; {θ}^{*} ) ≅ {p}_{x} ( x ; \hat{θ} ) exp \{ - \frac{1}{2} {( {θ}^{*} - \hat{θ} )}^{′} I ( \hat{θ} ) ( {θ}^{*} - \hat{θ} ) \} \qquad ( 19 )$$

Where θ* is an arbitrary value of the parameter \hat{θ} is the maximum likelihood estimate (MLE) of θ, and I(θ) is the Fisher's information matrix (FIM). The components of the FIM for PDF parameters θₖ, θₜ are given by

$${I}_{{θ}_{k} , {θ}_{t}} ( θ ) = - E ( \frac{{\partial }^{2} {Inp}_{x} ( x ; θ}{\partial {θ}_{k} \partial {θ}_{t}} ) . \qquad ( 20 )$$

The approximation is valid only for θ* in the vicinity of the MLE (and the true value). Second, the MLE \hat{θ} is approximately Gaussian with mean equal to the true value θ and covariance equal to I⁻¹(θ) or

$${p}_{θ} ( \hat{θ} ; θ ) ≅ {( 2 π )}^{- P / 2} {\vert I ( \hat{θ} ) \vert}^{1 / 2} exp \{ - \frac{1}{2} {( θ - \hat{θ} )}^{′} I ( \hat{θ} ) ( θ - \hat{θ} ) \} \qquad ( 21 )$$

where P is the dimension of θ. Note that we use \hat{θ} in evaluating the FIM in place of θ, which is unknown. This is allowed because I⁻¹(θ) has a weak dependence on θ. The approximation is valid only for θ in the vicinity of the MLE.

To apply (18), \hat{θ} takes the place of z, and H₀(z) is the hypothesis that \hat{θ} is the true value of θ. We substitute (19) for pₓ(x|H₀(z)) and (21) p_{z}(z|H₀(z)). Under the stated conditions, the exponential terms in approximations (19), and (21) become 1. Using these approximations, we arrived at

$${\hat{p}}_{x} ( x \vert {H}_{1} ) = \frac{{p}_{x} ( x ; \hat{θ} )}{{( 2 π )}^{- P / 2} {\vert I ( \hat{θ} ) \vert}^{1 / 2}} {\hat{p}}_{θ} ( \hat{θ} \vert {H}_{1} ) \qquad ( 22 )$$

which agrees with the PDF approximation from asymptotic theory.

To compare (18) and (22), we note that for both, there is an implied sufficiency requirement for z and \hat{θ}, respectively. Specifically, H₀(z) must remain in the ROS of z, whereas \hat{θ} must be asymptotically sufficient for θ. However, (18) is more general since (22) is valid only when all of the features are ML estimators and only holds asymptotically for large data records with the implication that \hat{θ} tends to Gaussian, whereas (18) has no such implication. This is particularly important in upstream processing, where there has not been significant data reduction, and asymptotic results do not apply. Using (18), we can make simple adjustments to the reference hypothesis to match the data better and avoid the PDF tails (such as controlling variance), where we are certain that we remain in the ROS of z. As an aside, we note that (10) with a fixed reference hypothesis is even more general since there is no implied sufficiency requirement for z.

In many cases, it is difficult to derive the J-function for an entire processing chain. On the other hand, it may be quite easy to do it for one stage of processing at a time. In this case, the chain rule can be used to good advantage. The chain rule is just the recursive application of the PDF projection theorem. For example, consider a processing chain

$$x {->}^{{T}_{1} ( x )} y {->}^{{T}_{2} ( y )} w {->}^{{T}_{3} ( w )} z \qquad ( 23 )$$

The recursive use of (0.10) gives

$${p}_{x} ( x \vert {H}_{1} ) = \frac{{p}_{x} ( x \vert {H}_{0} ( y ) )}{{p}_{y} ( y \vert {H}_{0} ( y ) )} \frac{{p}_{y} ( y \vert {H}_{0}^{′} ( w ) )}{{p}_{w} ( w \vert {H}_{0}^{′} ( w ) )} \cdot \frac{{p}_{w} ( w \vert {H}_{0}^{″} ( z ) )}{{p}_{z} ( z \vert {H}_{0}^{″} ( z ) )} {p}_{z} ( z \vert {H}_{1} ) \qquad ( 24 )$$

where y=T₁(x), w=T₂(y), z=T₃(w), and H′₀(y), H′₀(w), H′₀(z) are reference hypotheses (possibly data-dependent) suited to each stage in the processing chain. By defining the J-function of each stage, we may write the above as

$${p}_{x} ( x \vert {H}_{1} ) = J ( x , {T}_{1} , {H}_{0} ( y ) ) J ( y , {T}_{2} , {H}_{0}^{′} ( w ) ) J ( w , {T}_{3} , {H}_{0}^{″} ( z ) ) {p}_{z} ( z \vert {H}_{1} ) . \qquad ( 25 )$$

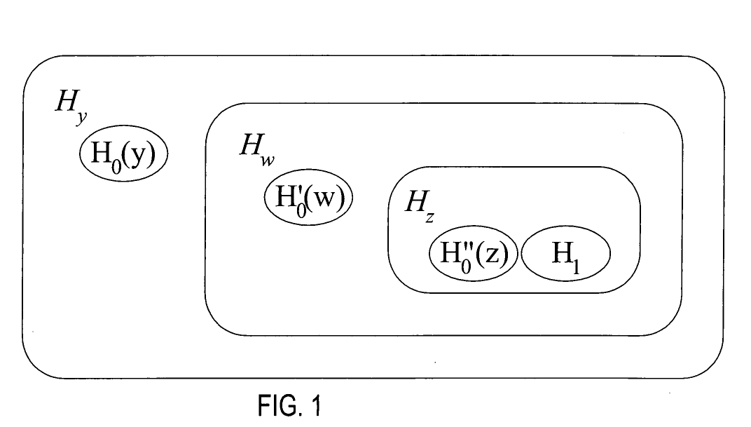

There is a special embedded relationship between the hypotheses. Let H_{y}, H_{w}, and H_{z} be the ROSs of y, w, and z, respectively. Then, we have H_{z}⊂H_{w}⊂H_{y}. If we use variable reference hypotheses, we also must have H″₀(z)εH_{z}, H′₀(w)εH_{w}, and H₀(y)εH_{y}. This embedding of the hypotheses is illustrated in FIG. 1. The condition H₁εH_{z} is the ideal situation and is not necessary to produce a valid PDF. The factorization (24), together with the embedding of the hypotheses, we call the chain-rule processor (CRP).

We now summarize the various methods we have discussed for computing the J-function. For modules using a fixed reference hypothesis, care must be taken in calculation of the J-function because the data is more often than not in the tails of the PDF. For fixed reference hypotheses, the J-function is

$$J ( x , T , {H}_{0} ) = \frac{{p}_{x} ( x \vert {H}_{0} )}{{p}_{z} ( z \vert {H}_{0} )} . \qquad ( 26 )$$

The numerator density is usually of a simple form, so it is known exactly. The denominator density p_{z}(z|H₀) must be known exactly or approximated carefully so that it is accurate even in the far tails of the PDF. The saddlepoint approximation (SPA) provides a solution for cases when the exact PDF cannot be derived but the exact moment-generating function is known. The SPA is known to be accurate in the far tails of the PDF.

For a variable reference hypotheses, the J-function is

$$J ( x , T , {H}_{0} ( z ) ) = \frac{{p}_{x} ( x \vert {H}_{0} ( z ) )}{{p}_{z} ( z \vert {H}_{0} ( z ) )} . \qquad ( 27 )$$

Modules using a variable reference are usually designed to position the references hypothesis at the peak of the denominator PDF, which is approximated by the CLT.

A special case of the variable reference hypothesis approach is the ML method, when z is an MLE. Whenever the feature is also a ML estimate and the asymptotic results apply (the number of estimated parameters is small and the amount of data is large), the two methods are identical. The variable reference hypothesis method is more general because it does not need to rely on the CLT.

One-to-one transformations do not change the information content of the data, but they are important for feature conditioning prior to PDF estimation. Recall from that the PDF projection theorem is a generalization of the change-of-variables theorem for 1:1 transformations. Thus, for 1:1 transformations, the J-function reduces to the absolute value of the determinant of the Jacobian matrix (4)
J(x,T)=|J_{T}(x)| (28)

Application of the PDF projection theorem to classification is performed by substituting (18) into (1). In other words, we implement the classical Neyman-Pearson classifier but with the class PDFs factored using the PDF projection theorem

$${j}^{*} = arg {max}_{j} \frac{{p}_{x} ( x \vert {H}_{0 , j} ( {z}_{j} ) )}{{p}_{z} ( z \vert {H}_{0 , j} ( {z}_{j} ) )} {\hat{p}}_{z} ( {z}_{j} \vert {H}_{j} ) at {z}_{j} = {T}_{j} ( x ) \qquad ( 29 )$$

where we have allowed for class-dependent, variable, reference hypotheses.

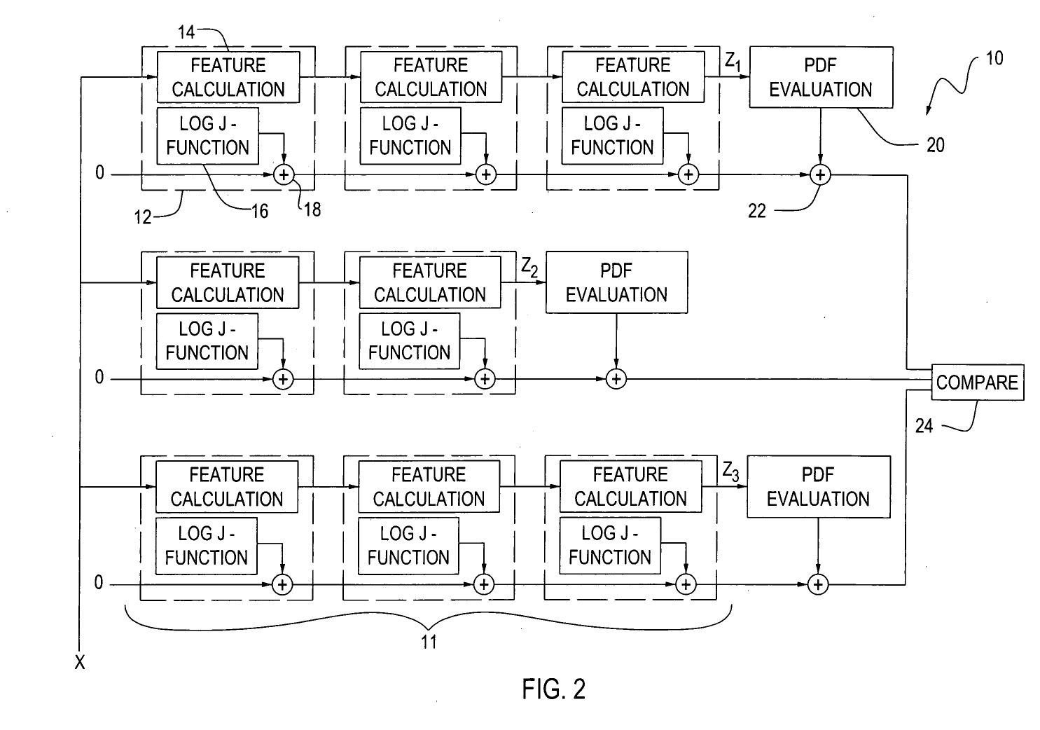

FIG. 2 shows an example of a classifier 10 constructed with the architecture of the current invention. Raw data X having a plurality of time samples and falling into a plurality of classes is provided to the classifier 10. Raw data X is provided to chains 11 of class-specific modules 12. Each class is associated with a chain 11 of class-specific modules 12.

Each module 12 receives a feature calculation input which it provides to a feature calculation section 14. The feature calculations section performs calculations on the feature calculation input. The feature calculation input can be data or previously computed features from previous feature calculation outputs. Upon completing these calculations the module 12 provides a feature calculation output. Each module 12 also includes a Log J-Function section 16. The Log J-Function section 16 computes a correction factor that can be summed at summer 18 with the correction factors provided by the correction output of Log J-Function sections 16 in previous modules 12 to allow chaining of modules 12.

Modules 12 are joined in chains so that the first module in the chain receives raw data X at its feature calculation input and zero or a null value at its correction input. Each succeeding module 12 then receives its inputs from the preceding module 12 in the chain 11. Chain 11 can have any number of modules 12. The last module 12 in the chain 11 is joined to a probability density function evaluation section 20. The probability density function evaluation section 20 receives the feature calculation output from the last module in the chain and converts it into a form for summing at summer 22 with the correction output of the last module 12 in the chain 11. The output of summer 22 applies the probability density function for the class associated with the chain 11 to the raw data and produces a value indicating the likelihood that the raw data is a member of the class. A compare module 24 is joined to the output of each summer 22. The compare module 24 provides an output that indicates that the raw data X is of the class having features indicated by high values at the outputs of summers 22.

Class specific modules 12 have been built for feature transformations including various invertible transformations, spectrograms, arbitrary linear functions of exponential random values, the autocorrelation function (contiguous and non-contiguous), autoregressive parameters, cepstrum, order statistics of independent random values, and sets of quadratic forms. These represent some of the many feature transformations that can be incorporated as modules in a classifier built using the chain rule.

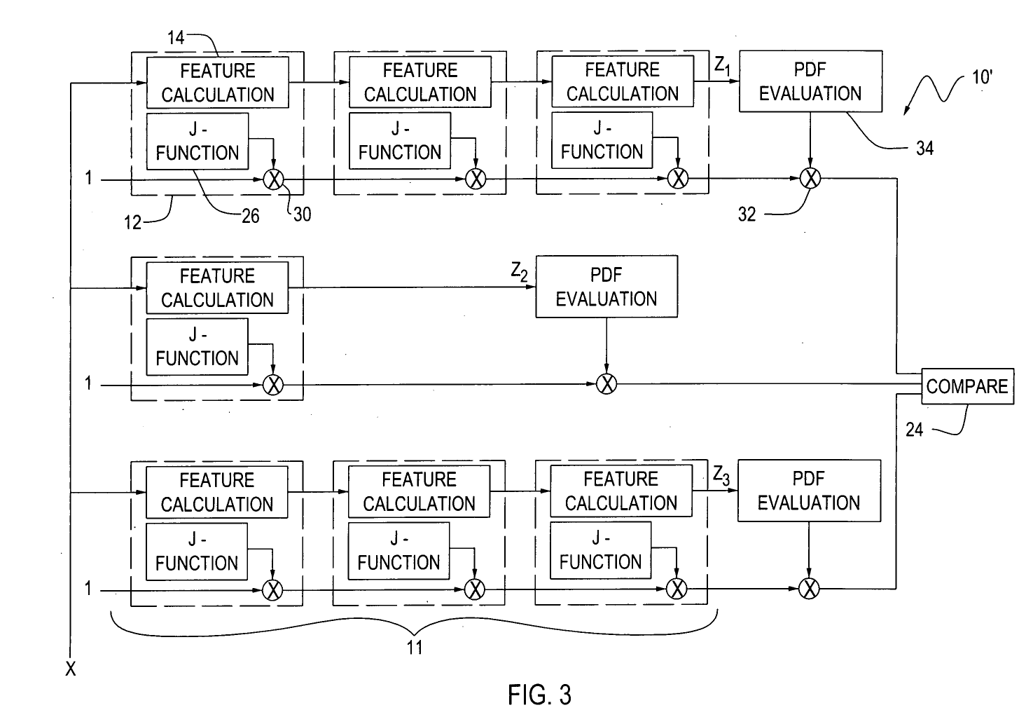

FIG. 3 shows an example of a classifier 10′ constructed using an alternative embodiment of the architecture of the current invention. This architecture utilizes a J-Function 26, instead of a Logarithmic J-Function 18, in each module 12. This J-Function can be multiplied with the previous correction outputs at multiplier 30. The probability function evaluation section 34 can then provide an output which can be multiplied at 32 with the output of the last module. The multiplied output can then be used as the probability density function for the feature.

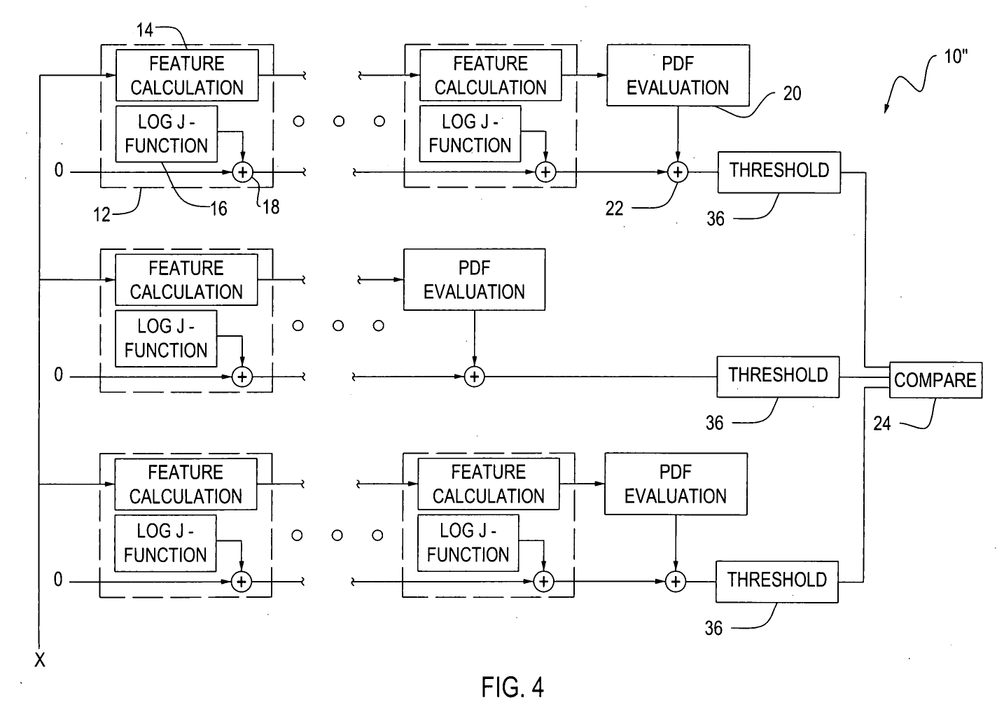

FIG. 4 is another alternate embodiment 10″ of a classifier utilizing the architecture taught by the current invention. In this embodiment, a thresholding module 36 is provided for each class between summer 22 and compare module 24. Thresholding module 36 does not allow summer 22 to send a value to compare module 24 if the value does not exceed a threshold value. This threshold value can be set as one value for all of the chains or set independently for each chain. The threshold value can be calculated based on the level of background noise in the raw input data. Use of thresholding modules 36 allows weak samples to be ignored rather than forcing them into a poorly fitting class. While thresholding is shown applied to the log J-function embodiment, it can also be applied to the J-function embodiment of the invention.

The J-function and the feature PDF provide a factorization of the raw data PDF into trained and untrained components. The ability of the J-function to provide a “peak” at the “correct” feature set gives the classifier a measure of classification performance without needing to train. In fact, it is not uncommon that the J-function dominates, eliminating the need to train at all. This we call the feature selectivity effect. For a fixed amount of raw data, as the dimension of the feature set decreases, indicating a larger rate of data compression, the effect of the J-function compared with the effect of the feature PDF increases. An example where the J-function dominates is a bank of matched filter for known signals in noise. If we regard the matched filters as feature extractors and the matched filter outputs as scalar features, it may be shown that this method is identical to comparing only the J-functions. Let zⱼ=|w′ⱼx|², where wⱼ is a normalized signal template such that w′ⱼwⱼ=1. Then, under the white (independent) Gaussian noise (WGN) assumption, zj is distributed λ²(1). It is straightforward to show that the J-function is a monotonically increasing function of zⱼ. Signal waveforms can be reliably classified using only the J-function and ignoring the PDF of under each hypothesis. The curse of dimensionality can be avoided if the dimension of zⱼ is small for each j. This possibility exists, even in complex problems, because zⱼ is required only to have information sufficient to separate class Hⱼ from a specially chosen reference hypothesis H_{0,j}.

This invention has been disclosed in terms of certain embodiments. It will be apparent that many modifications can be made to the disclosed apparatus without departing from the invention. Therefore, it is the intent of the appended claims to cover all such variations and modifications as come within the true spirit and scope of this invention.

1. A modularized classifier receiving raw input data having a plurality of features comprising:
a plurality of class specific modules, each class specific module having a feature calculation input, a feature calculation section, a feature calculation output, a correction input, a correction section and a correction output, said class specific modules being arranged in chains of class specific modules having at least one class specific module, each chain being associated with one class, whereby the first class specific module in the chain of class specific modules receives the raw input data at the feature calculation input and a null value at the correction input, and the feature calculation input and the correction input of each intermediate class specific module in the chain is joined to the corresponding output of the preceding class specific module in the chain;
at least one probability density function evaluation module for each class joined to the feature calculation output of the last module in the chain of class specific modules, said at least one probability density function evaluation module having an evaluation output;
a combiner for each chain joined to the evaluation output of the probability density function evaluation module for the class and to the correction output of the last class specific module in the chain of class specific modules, said combiner providing a combined output of the correction output and the evaluation output; and
a compare module receiving the combined output from each combiner associated with each class, said compare module having a comparator output which outputs a signal indicating that the combiner output received is of the class associated with the combiner providing the combiner output having the highest value thus indicating the class of the raw input data.

2. The system of claim 1 wherein the correction section of each class specific module utilizes a variable reference hypothesis to optimize the numerical precision of the correction section.

3. The system of claim 2 wherein:
said combiner is a summer; and
said correction section computes a log J-function which is summed with the correction input and provided to the correction output.

4. The system of claim 3 further comprising a thresholding module positioned between each said combiner and said compare module to receive the value, said thresholding module eliminating all values below a predetermined threshold.

5. The system of claim 2 wherein:
said combiner is a multiplier; and
said correction section computes a J-function which is multiplied with the correction input and provided to the correction output.

6. The system of claim 5 further comprising a thresholding module positioned between each said combiner and said compare module to receive the value, said thresholding module eliminating all values below a predetermined threshold.

7. The system of claim 1 wherein said plurality of class specific modules are selected from feature transformations including various invertible transformations, spectrograms, arbitrary linear functions of exponential random values, the contiguous autocorrelation function, the non-contiguous autocorrelation function, autoregressive parameters, cepstrum, order statistics of independent random values, and sets of quadratic forms.
